(19) United States
(12) Patent Application Publication
(10) Pub. No.: US 2026/0287067 A1
(43) Pub. Date: Sep. 24, 2026

(54) HEIGHT-ADJUSTABLE VALVE STEM ASSEMBLY

(71) Applicant: SYSGRATION LTD., TAIPEI CITY (TW)

(72) Inventors: Meng Jie Tsai, TAIPEI CITY (TW); Szu Wei Chang, TAIPEI CITY (TW); SHENG-HAO LEE, TAIPEI CITY (TW)

(21) Appl. No.: 19/534,779

(22) Filed: Feb. 10, 2026

(30) Foreign Application Priority Data
Feb. 21, 2025 (TW) 114106515

(51) Int. Cl. F16K 1/36; B60C 29/00

(52) U.S. Cl. CPC F16K 1/36; B60C 29/005

(57) ABSTRACT

A height-adjustable valve stem assembly includes a base body having an interior for engaging with a valve stem and an exterior connected to a valve connector which is connected to a valve. An inner surface of the valve connector and an outer surface of the valve stem respectively include a first engaging section and a second engaging section. An adapter is engaged with an interior of the valve connector. An outer surface of the adapter is provided with a third engaging section to engage with the first engaging section. An inner surface of the adapter is provided with a fourth engaging section to engage with the second engaging section. The adapter enables mutual engagement between the base body and the valve stem, and through a relative engagement stroke among the base body, the adapter, and the valve stem, a height of the base body on the valve is adjusted.

### BACKGROUND OF THE INVENTION

### 1. Fields of the Invention

The present invention relates to the technical field of bicycle valves, and more particularly, to a valve stem assembly mounted on a tire rim and having adjustable height.

### 2. Descriptions of Related Art

In recent years, bicycles have become increasingly popular as both recreational and transportation tools, and bicycle riding has become a very popular competitive sport for both amateur enthusiasts and professionals. Currently, in the bicycle tire industry, rims with different functions are designed according to different requirements. For example, rims are designed with a longer radial length and a narrower axial width to reduce wind resistance experienced by the tire when the bicycle travels at high speed, thereby maintaining the rotational speed of the tire.

### SUMMARY OF THE INVENTION

The primary object of the present invention is to provide a height-adjustable valve stem assembly that is not directly installed on the top of a valve stem. The present invention does not increase the installation height, and does not require the installed valve stem to be specially manufactured.

The present invention provides a height-adjustable valve stem assembly, and comprises a base body having an interior configured for engaging with a valve stem. An exterior of the base body is connected to a valve connector. The valve connector is connected to a valve. An inner surface of the valve connector and an outer surface of the valve stem are respectively provided with a first engaging section and a second engaging section. An adapter is engaged with an interior of the valve connector. An outer surface of the adapter is provided with a third engaging section configured to engage with the first engaging section, and an inner surface of the adapter is provided with a fourth engaging section configured to engage with the second engaging section. The adapter enables mutual engagement between the base body and the valve stem, and through a relative engagement stroke among the base body, the adapter, and the valve stem, a height of the base body on the valve is adjusted.

Preferably, the valve stem has a first air inlet space therein. The valve connector has a second air inlet space therein. The adapter has a third air inlet space therein. The first air inlet space, the second air inlet space, and the third air inlet space are in communication with one another.

Preferably, air generated by the valve enters the tire through the second air inlet space of the valve connector, the third air inlet space of the adapter, and the first air inlet space of the valve stem.

Preferably, the base body is composed of a first base and a second base. The first base is provided with a through hole, and the through hole allows the valve stem to pass into an interior of the base body.

Preferably, a locking member is provided at the through hole of the first base. When the valve stem passes into the interior of the base body, the locking member engages the valve stem, thereby securing the valve stem firmly to the base body.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded perspective view of the present invention;

FIG. 2 is an assembled perspective view of the present invention;

FIG. 3 is a cross-sectional view, taken along line III-III of FIG. 2 of the present invention;

FIG. 4 is an operational cross-sectional view according to FIG. 3 of the present invention, and

FIG. 5 is a schematic view showing the present invention mounted on a tire rim.

### DETAILED DESCRIPTION OF THE PREFERRED EMBODIMENT

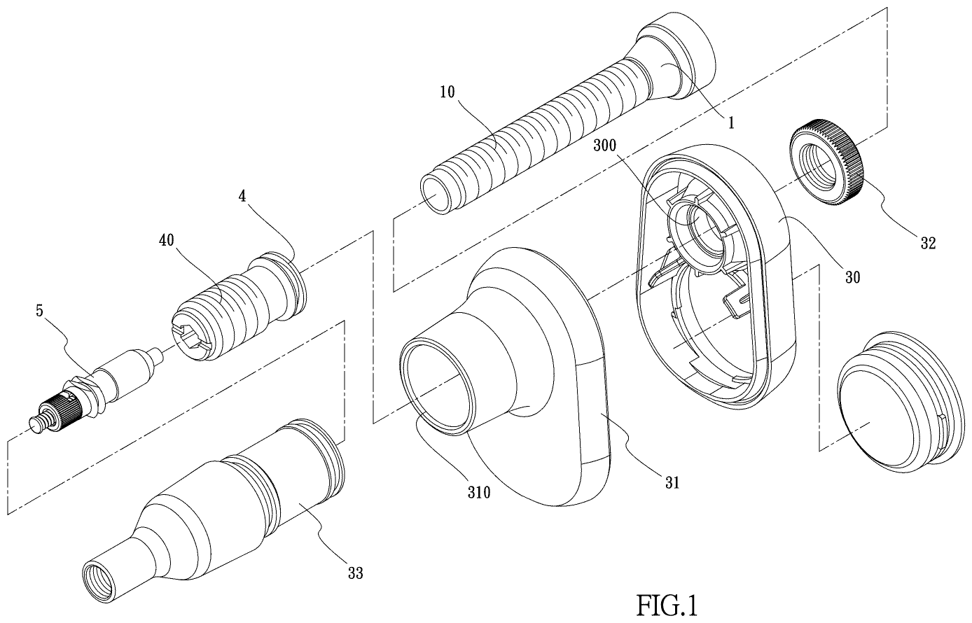

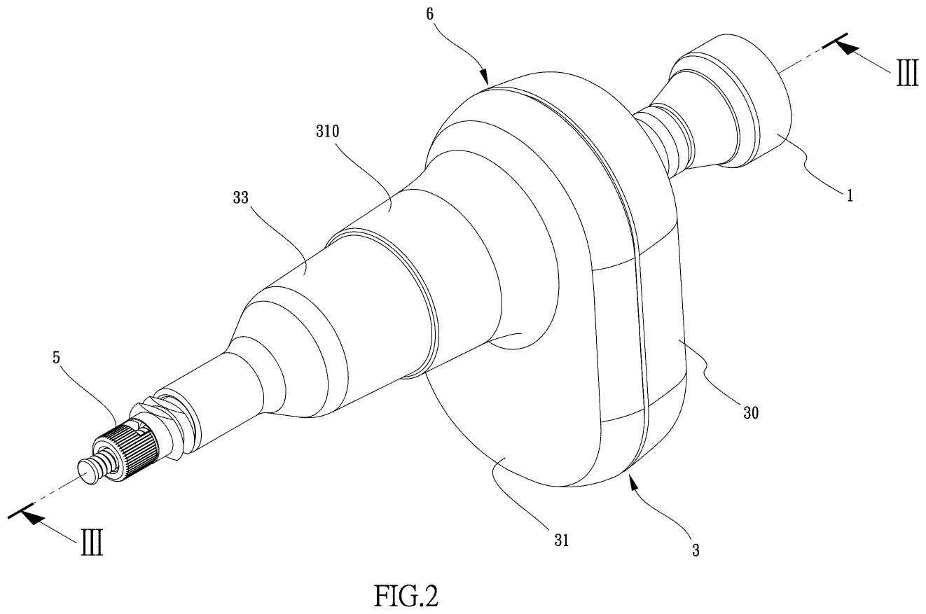

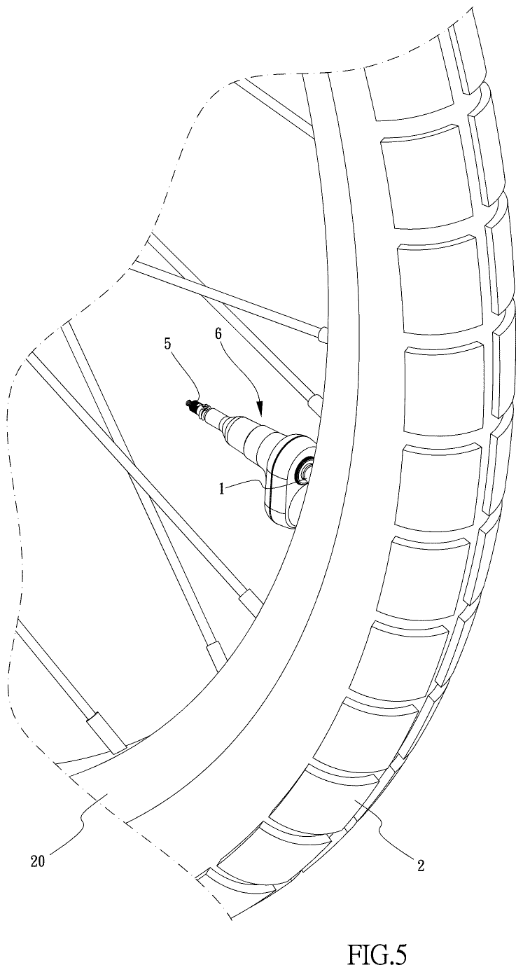

Referring to FIGS. 1 through 5, the present invention relates to a height-adjustable valve stem assembly, and comprises a valve stem 1 provided on a tire 2 of a bicycle, wherein an outer surface of the valve stem 1 has a second engaging section 10, and an interior of the valve stem 1 has a first air inlet space 11.

A base body 3 composed of a first base 30 and a second base 31. The first base 30 is provided with a through hole 300, and the through hole 300 allows the valve stem 1 to pass into an interior of the base body 3. A locking member 32 is provided at the through hole 300 of the first base 30, such that when the valve stem 1 passes into the interior of the base body 3, the valve stem 1 is engaged by the locking member 32, thereby securing the valve stem 1 firmly to the base body 3. The second base 31 has a connecting portion 310 and is connected to a valve connector 33 through the connecting portion 310. The valve connector 33 is assembled with a valve 5, wherein an inner surface and an interior of the valve connector 33 respectively have a first engaging section 330 and a second air inlet space 331.

An adapter 4 has a third air inlet space 42 therein and is engaged with an interior of the valve connector 33. An outer surface of the adapter 4 has a third engaging section 40 corresponding to the first engaging section 330, and an inner surface of the adapter 4 has a fourth engaging section 41 corresponding to the second engaging section 10. In this embodiment, the first air inlet space 11, the second air inlet space 331, and the third air inlet space 42 are in communication with one another.

During assembly, the adapter 4 is placed inside the valve connector 33 of the base body 3, and the third engaging section 40 is engaged with the first engaging section 330 of the valve connector 33. The valve stem 1 passes into the interior of the base body 3 through the through hole 300 of the first base 30, and the second engaging section 10 is engaged with the fourth engaging section 41 of the adapter 4. This arrangement secures the base body 3 to a rim 20 of the tire 2, and allows air generated by the valve 5 to enter the bicycle tire 2 through the second air inlet space 331 of the valve connector 33, the third air inlet space 42 of the adapter 4, and the first air inlet space 11 of the valve stem 1, thereby achieving an inflation effect for the tire 2.

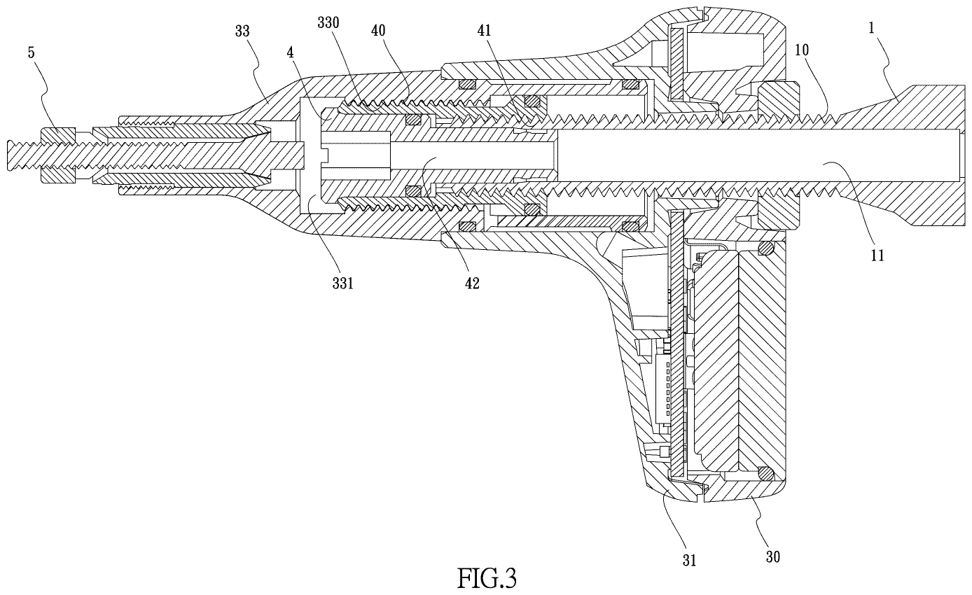

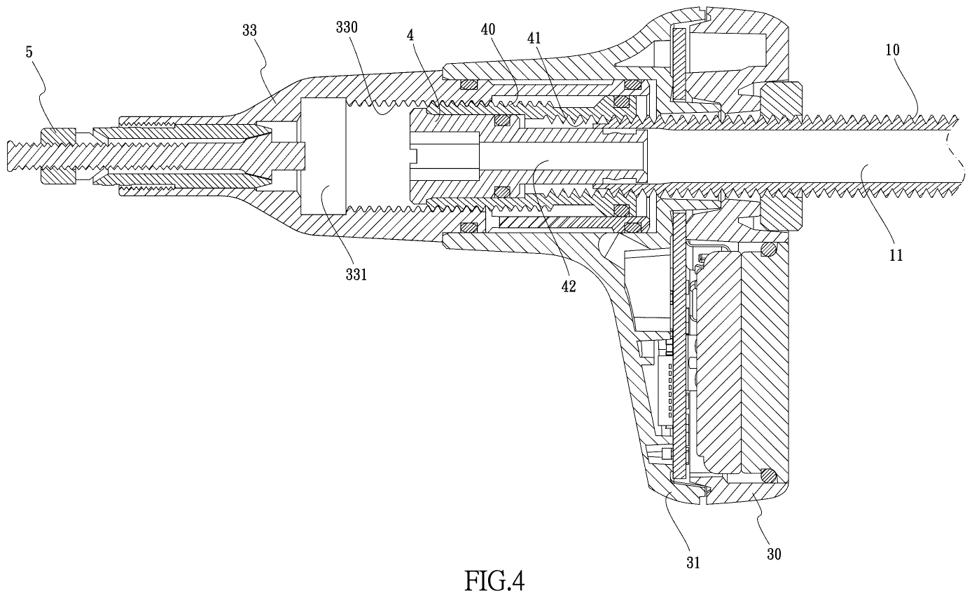

In implementation, the present invention tightens the valve connector 33 such that the third engaging section 40 and the fourth engaging section 41 of the adapter 4 are fully engaged with the first engaging section 330 of the valve connector 33 and the second engaging section 10 of the valve stem 1 respectively. This causes the base body 3 and the valve stem 1 to be in a tightly engaged state (as shown in FIG. 3). At this time, the base body 3 is adjusted to a lower position on the valve 5, and the distance between the base body 3 and the rim 20 is shorter. Conversely, by loosening the valve connector 33, the third engaging section 40 and the fourth engaging section 41 of the adapter 4 are partially engaged with the first engaging section 330 of the valve connector 33 and the second engaging section 10 of the valve stem 1 respectively. This causes the base body 3 and the valve stem 1 to be in a loosely engaged state (as shown in FIG. 4). At this time, the base body 3 is adjusted to a higher position on the valve 5, and the distance between the base body 3 and the rim 20 is longer. Accordingly, the valve stem assembly 6 of the present invention enables mutual engagement between the base body 3 and the valve stem 1 through the adapter 4, and through the relative engagement stroke among the base body 3, the adapter 4, and the valve stem 1, the height of the base body 3 of the valve stem assembly 6 on the valve 5 is adjusted to accommodate installation of different tires 2, thereby increasing practicality.

While we have shown and described the embodiment in accordance with the present invention, it should be clear to those skilled in the art that further embodiments may be made without departing from the scope of the present invention.

What is claimed is:

1. A height-adjustable valve stem assembly engaged with a valve stem of a tire, comprising:
a base body having an interior configured for engaging with the valve stem, an exterior of the base body connected to a valve connector, the valve connector being connected to a valve, wherein an inner surface of the valve connector is provided with a first engaging section, an outer surface of the valve stem is provided with a second engaging section, and
an adapter engaged with an interior of the valve connector, wherein an outer surface of the adapter is provided with a third engaging section so as to be engaged with the first engaging section, and an inner surface of the adapter is provided with a fourth engaging section so as to be engaged with the second engaging section, whereby the adapter enables mutual engagement between the base body and the valve stem, and through a relative engagement stroke among the base body, the adapter, and the valve stem, a height of the base body on the valve is adjusted.

2. The height-adjustable valve stem assembly as claimed in claim 1, wherein the valve stem has a first air inlet space therein, the valve connector has a second air inlet space therein, the adapter has a third air inlet space therein, and the first air inlet space, the second air inlet space, and the third air inlet space are in communication with one another.

3. The height-adjustable valve stem assembly as claimed in claim 2, wherein air generated by the valve sequentially enters the tire through the second air inlet space of the valve connector, the third air inlet space of the adapter, and the first air inlet space of the valve stem.

4. The height-adjustable valve stem assembly as claimed in claim 1, wherein the base body is composed of a first base and a second base, the first base is provided with a through hole, the valve stem passes into an interior of the base body via the through hole.

5. The height-adjustable valve stem assembly as claimed in claim 4, wherein a locking member is provided at the through hole of the first base, and when the valve stem passes into the interior of the base body, the locking member engages the valve stem, thereby securing the valve stem firmly to the base body.
